(19) United States
(12) Patent Application Publication
(10) Pub. No.: US 2025/0181990 A1
(43) Pub. Date: Jun. 5, 2025

(54) INFORMATION PROCESSING APPARATUS AND INFORMATION PROCESSING METHOD FOR MACHINE LEARNING

(71) Applicant: Rakuten Group, Inc., Tokyo (JP)

(72) Inventors: Hari Charan RAO, Tokyo (JP); Priyavrath Dakua, Tokyo (JP); Ankit Arora, Tokyo (JP); Saud Alam, Tokyo (JP); Eshant Sahu, Tokyo (JP)

(73) Assignee: Rakuten Group, Inc., Tokyo (JP)

(21) Appl. No.: 18/525,377

(22) Filed: Nov. 30, 2023

(51) Int. Cl. G06N 20/20

(52) U.S. Cl. CPC G06N 20/20

(57) ABSTRACT

A plurality of labels are accurately attached to data. An information processing apparatus includes: a creation unit configured to create a plurality of question sets, the plurality of question sets each being composed of a question and a plurality of labels indicating answers that are selectable for the question; and a training unit configured to train a plurality of learning models using the plurality of question sets.

### TECHNICAL FIELD

The present invention relates to an information processing apparatus and an information processing method for machine learning.

### BACKGROUND ART

In recent years, machine learning techniques have been used in order to solve various issues. Machine learning is performed by using trained learning models (machine learning models) that can solve general or specific tasks. Such learning models are trained using a large amount of training data, and, here, the training data is composed of data and labels for the data. An operation of labelling data is called annotation, and, conventionally, annotation has been manually performed by humans. However, such a manual operation is inefficient for preparing a large amount of training data, and there has been the possibility that quality cannot be ensured.

In order to address such an issue, a free or paid annotation tool configured to perform automatic labelling in order to efficiently perform annotation has been in widespread use. In addition, JP 2022-085670A discloses an information processing apparatus for evaluating the accuracy of generated training data, as a technique for ensuring the quality of generated training data (increasing the accuracy of annotation).

JP 2022-085670A is an example of related art.

### SUMMARY OF THE INVENTION

With conventional annotation techniques, it is expected that labels to be attached to data are accurately and efficiently generated, but such techniques have not provided a configuration for accurately attaching a plurality of types of labels to data.

The present invention has been made in light of the aforementioned issue, and an object of the present invention is to provide a mechanism for accurately attaching a plurality of labels to data.

In order to solve the aforementioned issue, one aspect of an information processing apparatus according to the present invention includes: a creation unit configured to create a plurality of question sets, the plurality of question sets each being composed of a question and a plurality of labels indicating answers that are selectable for the question, and a training unit configured to train a plurality of learning models using the plurality of question sets.

In order to solve the aforementioned issue, one aspect of an information processing method according to the present invention includes: creating a plurality of question sets, the plurality of question sets each being composed of a question and a plurality of labels indicating answers that are selectable for the question, and training a plurality of learning models using the plurality of question sets.

According to the present invention, a mechanism for accurately attaching a plurality of labels to data is provided.

The object, aspects, and effects of the present invention described above, as well as objects, aspects, and effects of the present invention that are not described above can be understood by those skilled in the art from the embodiments of the present invention described below by referring to the accompanying drawings and the scope of the claims.

### BRIEF DESCRIPTION OF THE DRAWINGS

FIG. 1 shows an exemplary functional configuration of an information processing apparatus according to an embodiment of the present invention.

FIG. 2 shows an exemplary hardware configuration of the information processing apparatus according to the embodiment.

FIG. 3 shows a flowchart of annotation processing.

FIG. 4 shows a flow of annotation by machine and annotation by humans.

FIG. 5A shows a screen example that is displayed on a display unit.

FIG. 5B shows a screen example that is displayed on the display unit.

FIG. 5C shows a screen example that is displayed on the display unit.

FIG. 5D shows a screen example that is displayed on the display unit.

FIG. 5E shows a screen example that is displayed on the display unit.

FIG. 5F shows a screen example that is displayed on the display unit.

FIG. 5G shows a screen example that is displayed on the display unit.

### EMBODIMENTS OF THE INVENTION

Embodiments of the present invention will now be described in detail with reference to the accompanying drawings. Out of the component elements described below, elements with the same functions have been assigned the same reference numerals, and description thereof is omitted. Note that the embodiments disclosed below are mere example implementations of the present invention, and it is possible to make changes and modifications as appropriate according to the configuration and/or various conditions of the apparatus to which the present invention is to be applied. Accordingly, the present invention is not limited to the embodiments described below. The combination of features described in these embodiments may include features that are not essential when implementing the present invention.

An information processing apparatus according to the present embodiment creates a plurality of question sets based on an input operation performed by the user. Each question set is composed of a question and a plurality of labels indicating answers that can be selected for the question. The information processing apparatus then trains a plurality of learning models using the plurality of question sets. In addition, the information processing apparatus acquires a data set that includes a plurality of items targeted for labelling (annotation) and applies the plurality of items to a plurality of learning models, thereby predicting and outputting labels for the question sets.

### Functional Configuration of Information Processing Apparatus

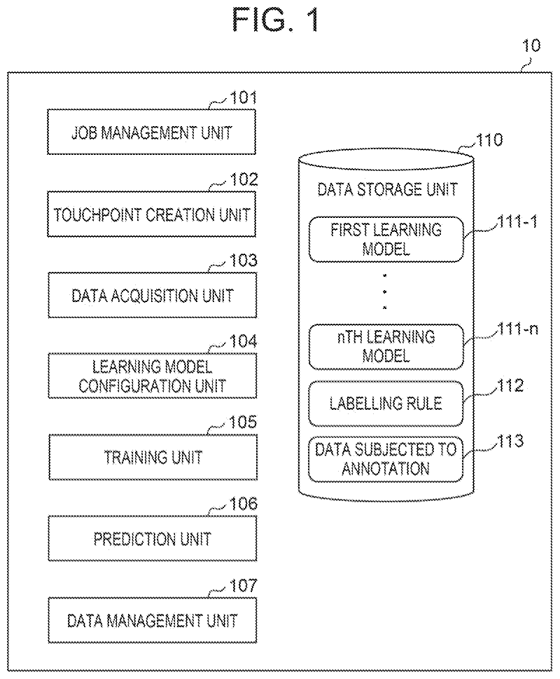

FIG. 1 shows an example of a functional configuration of an information processing apparatus 10 according to the present embodiment.

The information processing apparatus 10 shown in FIG. 1 includes a job management unit 101, a touchpoint creation unit 102, a data acquisition unit 103, a learning model configuration unit 104, a training unit 105, a prediction unit 106, a data management unit 107, and a data storage unit 110. The data storage unit 110 is configured to store a first learning model 111-1 to an nth learning model 111-n (n is a natural number that is two or greater), a labelling rule 112, and data 113 subjected to annotation.

The job management unit 101 manages a job including a series of processing that is performed when annotation is performed on one data set. The touchpoint creation unit 102 creates a plurality of touchpoints. In the present embodiment, each touchpoint is a question set composed of a question and a plurality of labels (also referred to as “values”) indicating answers that can be selected for the question. The data acquisition unit 103 acquires a data set that includes a plurality of items targeted for annotation. Specifically, the data acquisition unit 103 acquires a data set composed of a list of items targeted for annotation. The data acquisition unit 103 acquires a data set based on an input operation performed by the user or in accordance with a predetermined program, for example. The learning model configuration unit 104 configures a plurality of learning models that are used for labelling items targeted for annotation.

The training unit 105 trains learning models. The training unit 105 trains the first learning model 111-1 to the nth learning model 111-n, for example. Each of the first learning model 111-1 to the nth learning model 111-n is a learning model trained using labelled data in the past, and corresponds to a weakly supervised learning model. Each of the first learning model 111-1 to the nth learning model 111-n may be a learning model configured to identify the attribute of a specific item, or a learning model configured to identify the attribute of an item in a general-purpose manner.

The prediction unit 106 applies a plurality of items targeted for annotation, to one of the first learning model 111-1 to the nth learning model 111-n that have been trained, thereby predicting labels to be attached to the items. In the present embodiment, the prediction unit 106 applies the plurality of items to a plurality of learning models configured by the learning model configuration unit 104, and thereby predicts labels to be attached to the items.

The data management unit 107 stores, in the data storage unit 110, the first learning model 111-1 to the nth learning model 111-n trained by the training unit 105, and data labelled by the prediction unit 106, that is, data 113 subjected to annotation. In addition, the data management unit 107 may store the labelling rule 112 in the data storage unit 110. The labelling rule 112 will be described later.

### Hardware Configuration of Information Processing Apparatus

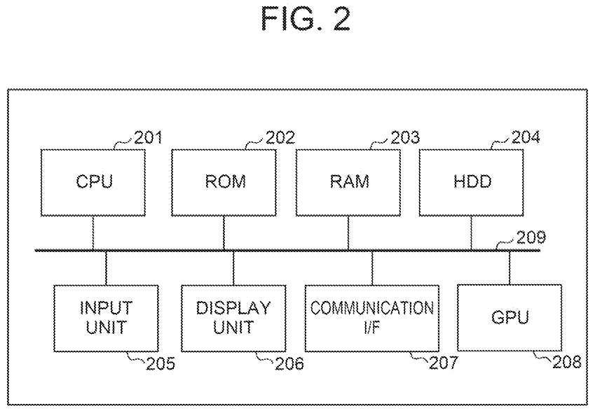

Next, an exemplary hardware configuration of the information processing apparatus will be described. FIG. 2 is a block diagram showing an example of a hardware configuration of the information processing apparatus 10 according to the present embodiment.

The information processing apparatus 10 according to the present embodiment can be implemented on one or a plurality of any computers, mobile devices, or other processing platforms.

Although FIG. 2 shows an example in which the information processing apparatus 10 is implemented on a single computer, the information processing apparatus 10 of the present embodiment may be implemented on a computer system including a plurality of computers. The plurality of computers may be connected to each other via a wired or wireless network to enable communication between the computers.

As shown in FIG. 2, the information processing apparatus 10 may include a CPU (Central Processing Unit) 201, a ROM (Read Only Memory) 202, a RAM (Random Access Memory) 203, an HDD (Hard Disk Drive) 204, an input unit 205, a display unit 206, a communication I/F (interface) 207, a GPU (Graphics Processing Unit) 208, and a system bus 209. The information processing apparatus 10 may also include an external memory.

The CPU 201 performs overall control of operations of the information processing apparatus 10, and controls the constituent elements (202 to 208) via the system bus 209 that is a data transmission path.

The ROM 202 is a non-volatile memory that stores control programs and the like that are required for the CPU 201 to execute processing. Note that the programs may also be stored in a non-volatile memory such as the HDD 204 or an SSD (Solid State Drive), an external memory such as a removable storage medium (not illustrated), or the like.

The RAM 203 is a volatile memory, and functions as a main memory of the CPU 201, a work area, or the like. That is to say, when executing processing, the CPU 201 realizes various functional operations by loading a necessary program and the like from the ROM 202 to the RAM 203, and executing the program and the like. The RAM 203 may include the data storage unit 110 shown in FIG. 1.

The HDD 204 stores various types of data and various types of information required when the CPU 201 performs processing using a program, for example. In addition, the HDD 204 stores various types of data and various types of information obtained by the CPU 201 performing processing using a program and the like, for example.

The input unit 205 is composed of a keyboard and a pointing device such as a mouse.

The display unit 206 is composed of a monitor, such as a liquid crystal display (LCD). When configured in combination with the input unit 205, the display unit 206 may also function as a GUI (Graphical User Interface). A later-described input operation (including a selecting operation and the like) may be performed by the user via the input unit 205 or the GUI.

The communication I/F 207 is an interface that controls communication between the information processing apparatus 10 and external apparatuses.

The communication I/F 207 provides an interface with a network, and executes communication with external apparatuses via the network. Various types of data, various parameters, and the like are transmitted/received to/from the external apparatuses via the communication I/F 207. In the present embodiment, the communication I/F 207 may execute communication via a wired LAN (Local Area Network) or a dedicated line that complies with a communication standard, such as Ethernet (registered trademark). However, the network that can be used in the present embodiment is not limited to this and may be configured as a wireless network. This wireless network includes a wireless PAN (Personal Area Network) such as Bluetooth (registered trademark), ZigBee (registered trademark), and UWB (Ultra Wide Band). The wireless network also includes a wireless LAN (Local Area Network) such as Wi-Fi (Wireless Fidelity) (registered trademark), and a wireless MAN (Metropolitan Area Network) such as WiMAX (registered trademark). The wireless network further includes a wireless WAN (Wide Area Network) such as 4G or 5G. Note that it is sufficient for the network to connect devices to enable communication between them, and the communication standard, scale, and configuration are not limited to the above examples.

The GPU 208 is a processor specialized for image processing. The GPU 208 can perform predetermined processing in cooperation with the CPU 201.

At least some of the functions of the constituent elements of the information processing apparatus 10 shown in FIG. 1 can be realized by the CPU 201 executing a program. However, at least some of the functions of the constituent elements of the information processing apparatus 10 shown in FIG. 1 may operate as dedicated hardware. In this case, the dedicated hardware operates under the control of the CPU 201.

### Annotation Processing

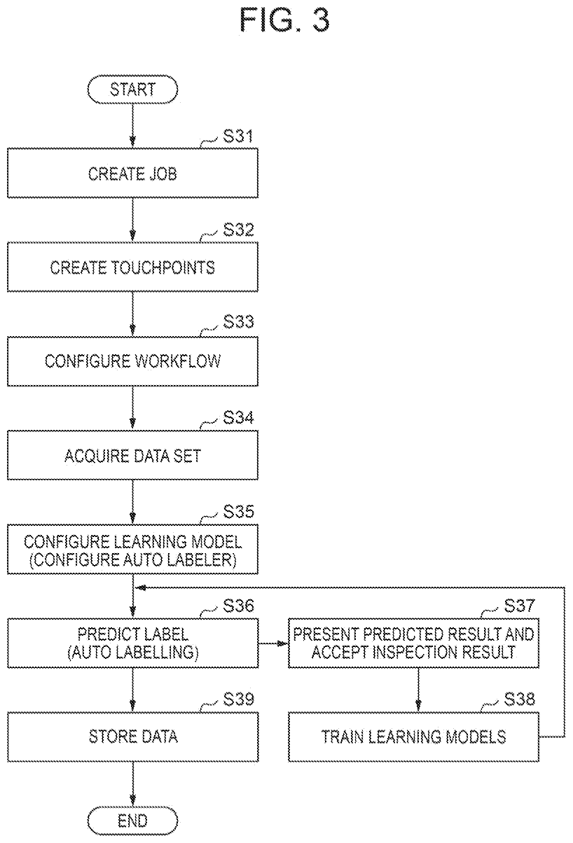

Next, a procedure of annotation processing according to the present embodiment will be described in detail. FIG. 3 shows a flowchart of annotation processing that is executed by the information processing apparatus 10. The information processing apparatus 10 performs processing for labelling one data set, as one annotation job (hereinafter, referred to as a “job”).

First, the job management unit 101 sets basic information of a job (job name, administrator, etc.) based on an input operation performed by the user (S31). The basic information is set so as not to coincide with another job. After the basic information of the job is set, the touchpoint creation unit 102 creates a plurality of touchpoints based on an input operation performed by the user (S32). As described above, each of the plurality of touchpoints (question sets) is composed of a question and a plurality of labels (also referred to as “values”) indicating answers that can be selected for the question.

When inputting a touchpoint, the user can select one of a plurality of different question types. In the present embodiment, there are three types, namely “Backfill”, “Binomial”, and “Identify”. “Backfill” is a touchpoint composed of a question and three or more dictionary values or custom values that serve as answers to the question. A dictionary value may be an attribute of a predetermined item such as a color or type of item (for example, a product) targeted for annotation. A custom value may be a value (for example, an attribute of an item) customized by the user. “Binomial” is a touchpoint composed of a question and two options or custom values that serve as answers to the question. “Identify” is a touchpoint that is applied to a use case where a dictionary value that differs for each item is set, and is composed of a question and a plurality of values that serve as answers to the question. That is to say, it can be said that “Backfill” is a question type that has three or more values (labels), “Binomial” is a question type that has two values (labels), and “Identify” is a question type that has at least two values (labels).

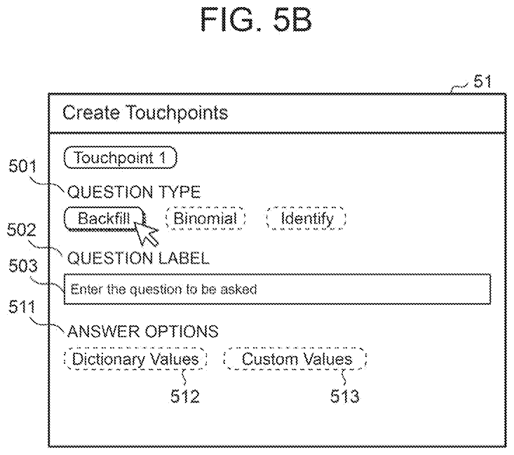

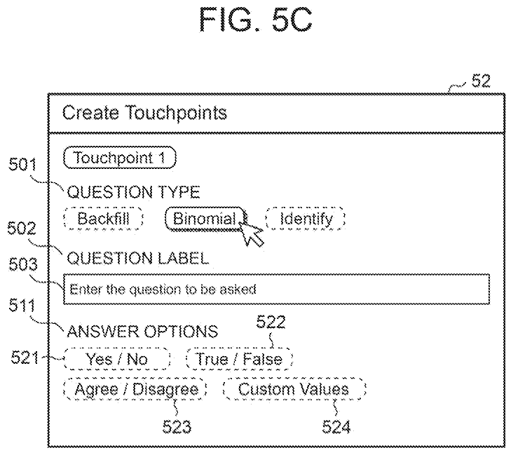

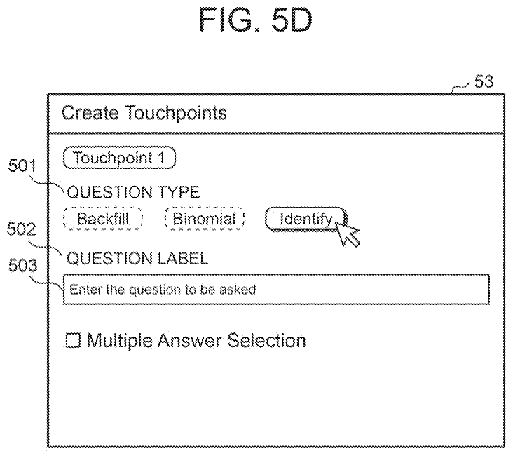

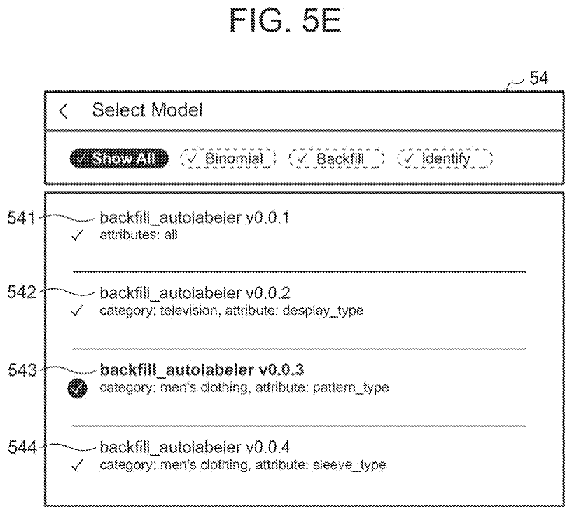

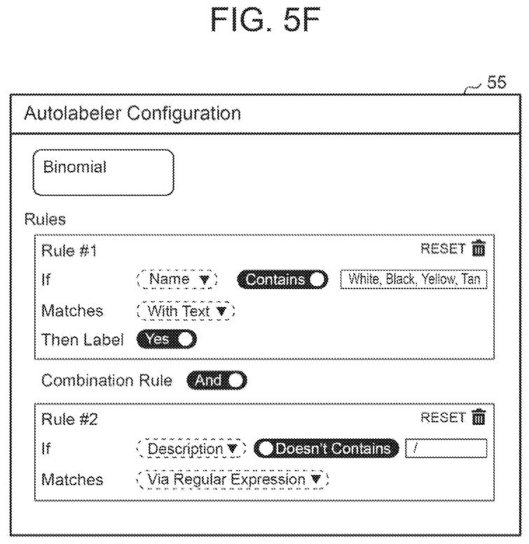

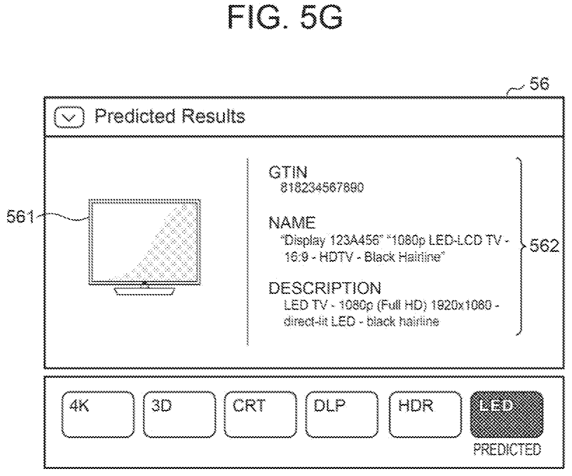

FIG. 5A shows an example of a screen that is displayed on the display unit 206 of the information processing apparatus 10 in S32 in FIG. 3. FIG. 5A shows a screen 50 for creating a first touchpoint 1 from among a plurality of touchpoints. As described above, a QUESTION TYPE 501 can be selected from three types, namely “Backfill”, “Binomial”, and “Identify”. the user can input the content of a question to an input space 503 under a QUESTION LABEL 502.

FIG. 5B shows an example of a screen 51 that is displayed when the user selects “Backfill” on the screen 50 shown in FIG. 5A. On the screen 51, the user can input the content of the question to the input space 503 under the QUESTION LABEL 502, and select Dictionary Values 512 or Custom Values 513 as ANSWER OPTIONS 511 for the question. Furthermore, the user can input data of dictionary values or custom values through manual input, uploading, or the like, on a screen (not illustrated) that is displayed in accordance with the selection.

FIG. 5C shows an example of a screen 52 that is displayed when the user selects “Binomial” on the screen 50 shown in FIG. 5A. On the screen 52, the user can input the content of the question to the input space 503 under the QUESTION LABEL 502, and select one of YES/NO 521, True/False 522, Agree/Disagree 523, and Custom Values 524 as ANSWER OPTIONS 511 for the question.

FIG. 5D shows an example of a screen 53 that is displayed when the user selects “Identify” on the screen 50 shown in FIG. 5A. On the screen 53, the user can input the question to the input space 503 below the QUESTION LABEL 502, and set answers that can be selected for the question.

As described with reference to FIGS. 5B to 5D, the user selects at least one of the question types “Backfill”, “Binomial”, and “Identify” for each touchpoint, and inputs a plurality of touchpoints. Accordingly, the touchpoint creation unit 102 can create a plurality of touchpoints. The plurality of touchpoints may be touchpoints of the same question type (for example, “Backfill”), or may be touchpoints of different question types (for example, “Backfill” and “Binomial”.

Next, the job management unit 101 configures a workflow for annotation (labelling) (S33). In the present embodiment, the job management unit 101 sets a flow related to inspection (check) by human after labelling in S36, based on an input operation performed by the user. The job management unit 101 performs setting such that the inspection is performed in one step (curation) or two steps (curation and review), for example. Curation corresponds to an operation of directly inspecting a predicted result, and review corresponds to inspecting the curation result. Furthermore, the job management unit 101 may perform setting such that the inspection is performed by one or more users. The result of such inspection corresponds to an inspection result that is accepted in S37.

Next, the data acquisition unit 103 acquires a data set composed of a list of items targeted for annotation (S34). The data acquisition unit 103 acquires the data set based on an input operation performed by the user (for example, an instruction to upload the data set or download the data set from a cloud) or in accordance with a predetermined program, for example. The data set includes at least information regarding a plurality of items targeted for annotation, and may further include text information such as identification information, description, and brand names of the items (or is associated with the items). The information regarding the items may be images, video images, or the like. The images and video images may be data, or may be information indicating where the images or the video images are, such as a URL (Uniform Resource Locator). The format of the data set may be one of data technique languages such as CSV, JSON, and ZIP format.

The data acquisition unit 103 may set a plurality of levels of priority according to the influence that the data set has on a learning model, in accordance with an input operation performed by the user. Assume that the user sets “high priority”, “intermediate priority”, or “low priority” for the data set, for example. Accordingly, when, in S36, the prediction unit 106 performs prediction processing on the data set that has a higher priority, the training unit 105 may perform training processing with a higher weight with reference to a result of inspecting the prediction. This may improve the training effect.

After the data set has been acquired, the learning model configuration unit 104 configures a learning model for labelling, in S36, the plurality of touchpoints created in S32 (S35). The learning model is configured to automatically label input data, and is also called an “auto labeler”. In this regard, the processing in S36 is equivalent to configuring an auto labeler. In S35, specifically, the learning model configuration unit 104 applies (allocates) the learning model to the plurality of touchpoints created in S32, based on an input operation performed by the user. The learning model may be one of the first learning model 111-1 to the nth learning model 111-n that have been trained and are stored in the data storage unit 110.

FIG. 5E shows an example of a screen 54 that is displayed on the display unit 206 at the time of the processing in S35. On the screen 54, learning models (auto labelers) that can be applied to all of the touchpoints of “Backfill”, “Binomial”, and “Identify” are displayed. Learning models 541 to 544 are trained learning models, and each may be one of the first learning model 111-1 to the nth learning model 111-n. In addition, below the learning models 541 to 544, item categories and item attributes that can be labelled (identified) by the learning models are displayed so as to aid the user in selecting a learning model. The learning model 541 is a general-purpose learning model capable of identifying all of the item categories and item attributes, for example. The learning model 542 is a learning model capable of identifying an “item attribute: display type” for an “item category: television”. The learning model 543 is a learning model capable of identifying an “item attribute; pattern type” for an “item category: men's clothing”. The learning model 544 is a learning model capable of identifying an “item attribute: sleeve type” for an “item category: men's clothing”.

The example in FIG. 5E indicates that the user has selected the learning model 543 based on the feature of a certain touchpoint out of the plurality of touchpoints created in S32. Accordingly, the learning model configuration unit 104 applies the learning model 543 to the touchpoint. In this manner, based on an input operation performed by the user, the learning model configuration unit 104 applies a learning model to each of the plurality of touchpoints created in S32.

If it is determined that there is no learning model appropriate for at least one of the plurality of touchpoints created in S32 among the first learning model 111-1 to the nth learning model 111-n, the user can give an instruction to input a labelling rule (labelling function). When, for example, an attribute having a domain that is different from those of the attributes of items that can be identified by the first learning model 111-1 to the nth learning model 111-n is desired to be identified, it may be determined that there is no appropriate learning model. The learning model configuration unit 104 displays an input screen for labelling rules on the display unit 206 in accordance with the instruction. The learning model configuration unit 104 then configures a labelling rule in accordance with an input operation performed by the user, and applies the labelling rule as a learning model of the touchpoint.

FIG. 5F shows an example of an input screen 55 for labelling rules. The screen 55 is a screen for setting a labelling rule for identifying one of the two values of a label, for a touchpoint having the question type “binomial”, from among the plurality of touchpoints created in S32. The labelling rule can be configured by one rule or a combination of a plurality of rules, based on the data set acquired in S34. The learning model configuration unit 104 analyzes the data set acquired in S34, creates an input screen for labelling rules based on information included in the data set, and displays the created input screen on the display unit 206. In this example, a case is envisioned in which the data set acquired in S34 includes text information related to items, and the text information includes at least a “Name” portion and a “Description” portion. The learning model configuration unit 104 generates the screen 55 based on the text information, and displays the generated screen 55 on the display unit 206.

The user sets a condition of the “Name” portion with respect to Rule #1 and sets a condition of the “Description” portion with respect to Rule #2, in accordance with an input operation performed on the screen 55, and performs setting so as to attach a predetermined label to an item that satisfies a condition. Accordingly, the learning model configuration unit 104 configures a learning model that attaches a predetermined label to an item that complies with Rule #1 and Rule #2.

The learning model configuration unit 104 can store a labelling rule created in this manner, as the labelling rule 112 in the data storage unit 110.

The learning model configured in S35 is one of the first learning model 111-1 to the nth learning model 111-n that have been trained, or a labelling rule set by the user, and is not a learning model trained in advance using all of the items of the data set acquired in S34. That is to say, the learning model configured in S35 is not configured to be capable of performing complete labelling of all of the items of the data set acquired in S34, and thus can be called a “weakly supervised model (weakly supervised algorithm)”.

In the processing up to this point, preparation for labelling is complete. Next, the prediction unit 106 predicts labels for the items included in the data set acquired in S34, with respect to the plurality of touchpoints created in S32, using a plurality of learning models applied to the plurality of touchpoints (S36). That is to say, the prediction unit 106 labels the items. Processing in S36 is automatic labelling that is performed by the learning model (auto labeler) configured in S35, and can be referred to as “auto labelling”.

After the data set has been labelled, the job management unit 101 displays the predicted results (labelling results) on the display unit 206, so as to be presented to the user (S37). FIG. 5G shows an example of a screen 56 for predicted results. Information regarding the items included in the data set acquired in S34 is displayed on the screen 56. An image of an item 561 and text information 562 regarding the item are an example of such information. “GTIN” is a product identification code of the item 561. “NAME” is the name of the item 561. “DESCRIPTION” is a description of the item 561.

In addition, a result of attaching a label “LED”, which is a predicted label, to the item 561 is displayed on the screen 56, as a result predicted for one of the plurality of touchpoints created in S32 by the learning model configured in S35. On the screen 56, in order to indicate that “LED” is a predicted result, “LED” is displayed in a mode different from those of the other labels, and an index “PREDICTED” indicating that “LED” is a predicted result is displayed near “LED”. In this manner, the job management unit 101 displays a predicted result such that the user can recognize a predicted label from among a plurality of labels (values).

The user can inspect the predicted result on the screen 56 displayed on the display unit 206, and feed back the inspection result. A flow related to the inspection is the flow set in S33, and, here, one-step (curation) inspection by one user is envisioned. Curation corresponds to an operation of directly inspecting the predicted result, and the user feeds back the inspection result.

A configuration may be adopted in which, if it is determined that the predicted result on the screen 56 is correct, for example, the user does not feed back the inspection result, and if it is determined that the predicted result is not correct, the user feeds back an inspection result indicating a correct (corrected) label (in the example in FIG. 5G, one of “4K”, “3D”, “CRT”, “DLP”, and “HDR”, or a custom value). The inspection result that is fed back is not limited thereto, and, if it is determined that the predicted result is correct, the user may feed back an inspection result indicating that the predicted result is correct. The training unit 105 accepts the inspection result (S37).

The job management unit 101 causes predicted results for all of the items included in the data set acquired in S34 to be displayed on the display unit 206 in order, and the training unit 105 accepts a result of the user inspecting the predicted results.

In S33, when a flow related to inspection is set such that two steps (curation and review) are performed by one user, the one user performs, in curation, an operation of directly inspecting the predicted results, and then, in review, reviews the inspection result of curation. In addition, when a flow related to inspection is set such that two steps (curation and review) are performed by a plurality of users, one user performs, in curation, an operation of directly inspecting the predicted results, and, in review, another user then reviews the inspection result of curation. In two-step inspection, double check is performed, and thus it is easier to find a labelling error, realizing accurate feedback of the inspection result.

Upon accepting a result of inspecting one data set, the training unit 105 trains (i.e., retrains) learning models (S38). Here, the learning model that is trained is the learning model used in auto labelling in S36. After training, the prediction unit 106 again predicts labels for the items included in the data set acquired in S34 (S36). Next, presentation of the predicted results and acceptance of the inspection result (S37), and training of the learning model (S38) are repeated. If the user inspecting the predicted results determines that the predicted results include no error and there is no need for training, for example, the user gives an instruction to store data. Accordingly, the data management unit 107 stores, in the data storage unit 110, the first learning model 111-1 to the nth learning model 111-n trained by the training unit 105, and data 113 subjected to annotation, namely data labelled by the prediction unit 106 (S39). In addition, in a case where a labelling rule has been created, the data management unit 107 stores the labelling rule in the data storage unit 110 as the labelling rule 112.

Note that the training unit 105 may train the first learning model 111-1 to the nth learning model 111-n using the plurality of touchpoints created in S32, without using the data set acquired in S34 and the inspection results acquired in S37. After that, the training unit 105 may train the first learning model 111-1 to the nth learning model 111-n using the data set acquired in S34 and the inspection result acquired in S37. The training unit 105 can train the learning models in accordance with the structures and features of the plurality of touchpoints themselves.

The job management unit 101 then ends the job created in S31. Here, the job management unit 101 may store information regarding the job, in the data storage unit 110. The information regarding the job includes information set in S31 and the data created and acquired in S32 to S35, for example.

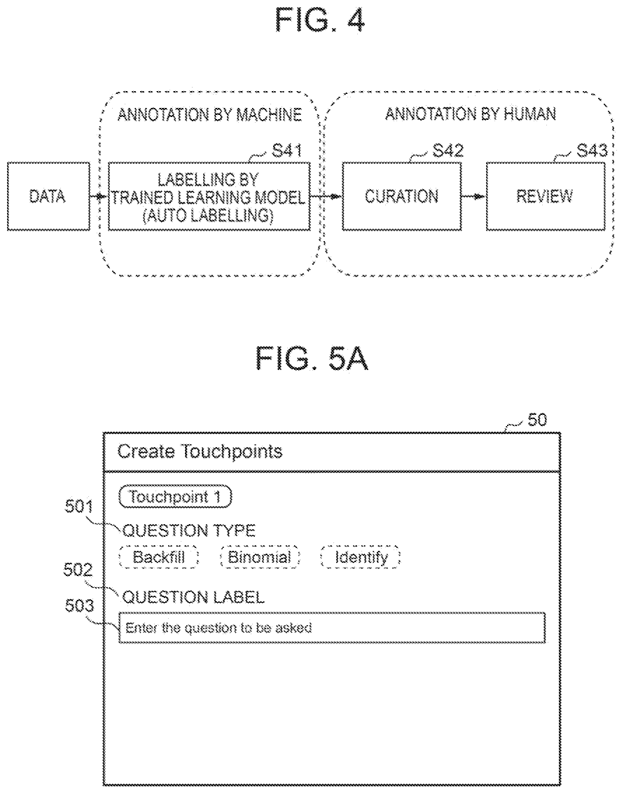

The features of annotation according to the present embodiment will be described with reference to FIG. 4. FIG. 4 is a diagram showing the features of annotation, specifically, a flow of annotation by machine, which is adopted in the present embodiment, and annotation by humans. Here, it is envisioned that labels are inspected in two steps as annotation by humans. The prediction unit 106 predicts labels for (performs labelling of) the items included in the data set using trained learning models (S41, and S36 in FIG. 3). Labelling in S41 is equivalent to auto labelling by machine. Next, the user visually confirming the predicted results inspects the items and the accuracy of the labels for the items in the first step, namely curation, and if there is any error, corrects the error to a correct label (S42). Next, in the second step, namely review, the inspection result of curation is reviewed (S43). In this manner, by combining annotation by machine and annotation by human, more accurate labelling is realized.

In addition, in the present embodiment, immediately after the inspection results are accepted in S37 in FIG. 3, learning models are trained (S38). Accordingly, the learning models can be reinforced (the annotation accuracy can be improved) in real time.

In addition, in the present embodiment, by storing, in the data storage unit 110, a learning model trained for another use in the past, the number of learning models that can be applied by the learning model configuration unit 104 in S35 in FIG. 3 increases, and a load of the user creating a labelling rule may be reduced.

Note that although a specific embodiment has been described above, the embodiment is a mere example and is not intended to limit the scope of the invention. The apparatus and method described in this specification may be implemented in forms aside from the embodiment described above. It is also possible to appropriately make omissions, substitutions, and modifications to the embodiment described above without departing from the scope of the invention. Implementations with such omissions, substitutions, and modifications are included in the scope of the patent claims and their equivalents, and belong to the technical scope of the present invention.

The disclosure includes the following embodiments.
[1] An information processing apparatus comprising: a creation unit configured to create a plurality of question sets, the plurality of question sets each being composed of a question and a plurality of labels indicating answers that are selectable for the question; and a training unit configured to train a plurality of learning models using the plurality of question sets.
[2] The information processing apparatus according to [1], further comprising: an acquisition unit configured to acquire a data set that includes a plurality of items targeted for labelling; and a prediction unit configured to predict labels for the plurality of question sets, by applying the plurality of learning models to the plurality of items.
[3] The information processing apparatus according to [2], further comprising a presentation unit configured to present the labels predicted by the prediction unit, to a user, wherein the training unit trains the plurality of learning models based on a result of the user inspecting the presented labels.
[4] The information processing apparatus according to [2] or [3], further comprising an allocation unit configured to allocate one of the plurality of learning models to each of the plurality of question sets, wherein the prediction unit predicts labels for the plurality of question sets, using the allocated learning model.
[5] The information processing apparatus according to any one of [2] to [4], wherein the plurality of learning models include a learning model trained in advance using a data set that is different from the data set.
[6] The information processing apparatus according to [5], wherein the plurality of learning models include one or more labelling rules set based on the data set.
[7] The information processing apparatus according to any one of [1] to [6], wherein the creation unit creates the plurality of question sets that have different question types, and the question types include a first type that takes three or more values and a second type that takes two values.
[8] An information processing method comprising: creating a plurality of question sets, the plurality of question sets each being composed of a question and a plurality of labels indicating answers that are selectable for the question; and training a plurality of learning models using the plurality of question sets.

### REFERENCE SIGNS LIST

10: Information processing apparatus
101: Job management unit
102: Touchpoint creation unit
103: Data acquisition unit
104: Learning model configuration unit
105: Training unit
106: Prediction unit
107: Data management unit
110: Data storage unit
111-1: First learning model
111-n: nth learning model
112: Labelling rule
113: Data subjected to annotation

What is claimed is:

1. An information processing apparatus comprising:
a creation unit configured to create a plurality of question sets, the plurality of question sets each being composed of a question and a plurality of labels indicating answers that are selectable for the question; and
a training unit configured to train a plurality of learning models using the plurality of question sets.

2. The information processing apparatus according to claim 1, further comprising:
an acquisition unit configured to acquire a data set that includes a plurality of items targeted for labelling; and
a prediction unit configured to predict labels for the plurality of question sets, by applying the plurality of learning models to the plurality of items.

3. The information processing apparatus according to claim 2, further comprising
a presentation unit configured to present the labels predicted by the prediction unit, to a user,
wherein the training unit trains the plurality of learning models based on a result of the user inspecting the presented labels.

4. The information processing apparatus according to claim 2, further comprising
an allocation unit configured to allocate one of the plurality of learning models to each of the plurality of question sets,
wherein the prediction unit predicts labels for the plurality of question sets, using the allocated learning model.

5. The information processing apparatus according to claim 2,
wherein the plurality of learning models include a learning model trained in advance using a data set that is different from the data set.

6. The information processing apparatus according to claim 5,
wherein the plurality of learning models include one or more labelling rules set based on the data set.

7. The information processing apparatus according to claim 1,
wherein the creation unit creates the plurality of question sets that have different question types, and the question types include a first type that takes three or more values and a second type that takes two values.

8. An information processing method comprising:
creating a plurality of question sets, the plurality of question sets each being composed of a question and a plurality of labels indicating answers that are selectable for the question; and
training a plurality of learning models using the plurality of question sets.
